(19) United States
(12) Patent Application Publication
(10) Pub. No.: US 2006/0016999 A1
(43) Pub. Date: Jan. 26, 2006

(54) Apparatus for displaying the necessary suntan lotion and the skin care

(75) Inventors: Jiann-Der Lee, Gueishan Township (TW); Chang-Bor Liao, Tucheng City (TW); Tsan-mu Kuo, Shenkeng Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: Angelfun Enterprises Co., Ltd., Shenkeng Shiang (TW)

(21) Appl. No.: 10/899,702

(22) Filed: Jul. 26, 2004

(51) Int. Cl. G01J 1/42

(52) U.S. Cl. 250/372

(57) ABSTRACT

An apparatus for displaying the necessary suntan lotion and the skin care includes a UVA sensor and a UVB sensor respectively electrically connected to an operational amplifier that is electrically connected to a micro-processor for transmitting signal to the micro-processor. A UVA/UVB selector and a skin property selector are respectively electrically connected to the micro-processor for providing a calculating factor to the micro-processor. A series of LED is electrically connected to the micro-processor for showing the suggests from the micro-processor. A speaker is electrically connected to the micro-processor for reminding the user to select a suitable suntan lotion.

### BACKGROUND OF THE INVENTION

1. Field of the Invention

The present invention relates to an apparatus, and more particularly to an apparatus for displaying the necessary suntan lotion and the skin care.

2. Description of Related Art

The ultraviolet (UV) rays are divided into UVA, UVB and UVC due to the wavelength thereof. It will cause a pathological change of skin or sediment melanin in the skin when human is exposed under the sunlight for a period of time. However, there is no apparatus to remind the human who need to select a suitable suntan lotion of skin care when being exposed under the sunlight.

The present invention has arisen to mitigate and/or obviate the above problem.

### SUMMARY OF THE INVENTION

The main objective of the present invention is to provide an improved apparatus that displays the necessary suntan lotion and the skin care.

To achieve the objective, the apparatus in accordance with the present invention a UVA sensor and a UVB sensor respectively electrically connected to an operational amplifier that is electrically connected to a micro-processor for transmitting signal to the micro-processor. A UVA/UVB selector and a skin property selector are respectively electrically connected to the micro-processor for providing a calculating factor to the micro-processor. A series of light emitting diodes is electrically connected to the micro-processor for showing the suggests from the micro-processor. A speaker is electrically connected to the micro-processor for reminding the user to select a suitable suntan lotion.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of an apparatus for displaying the necessary suntan lotion and the skin care in accordance with the present invention;

FIG. 2 is a top plan view of a panel of the apparatus for displaying the necessary suntan lotion and the skin care in accordance with the present invention; and

FIG. 3 is a curve chart of the motive spectrum of the skin-erythema, wherein measuring value from a corresponding one of the two selectors is calculated and transform to energy (unit−joule/m²) that hurts the human's skin.

### DETAILED DESCRIPTION OF THE INVENTION

The ultraviolet (UV) rays have a great changing range and differences due to the place and the time. However, the meteorological bureau cannot provide the UV exponent for the human, who being exposed under the sunlight, to select a necessary suntan lotion of a skin care to resist the sunlight.

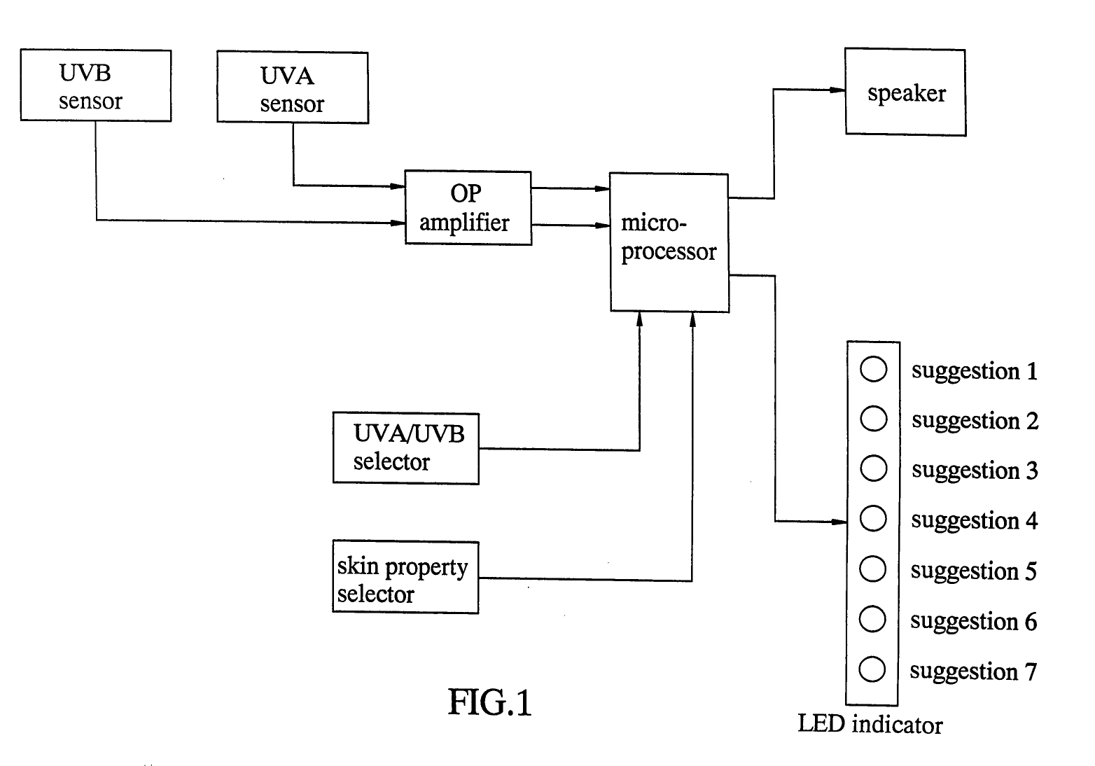

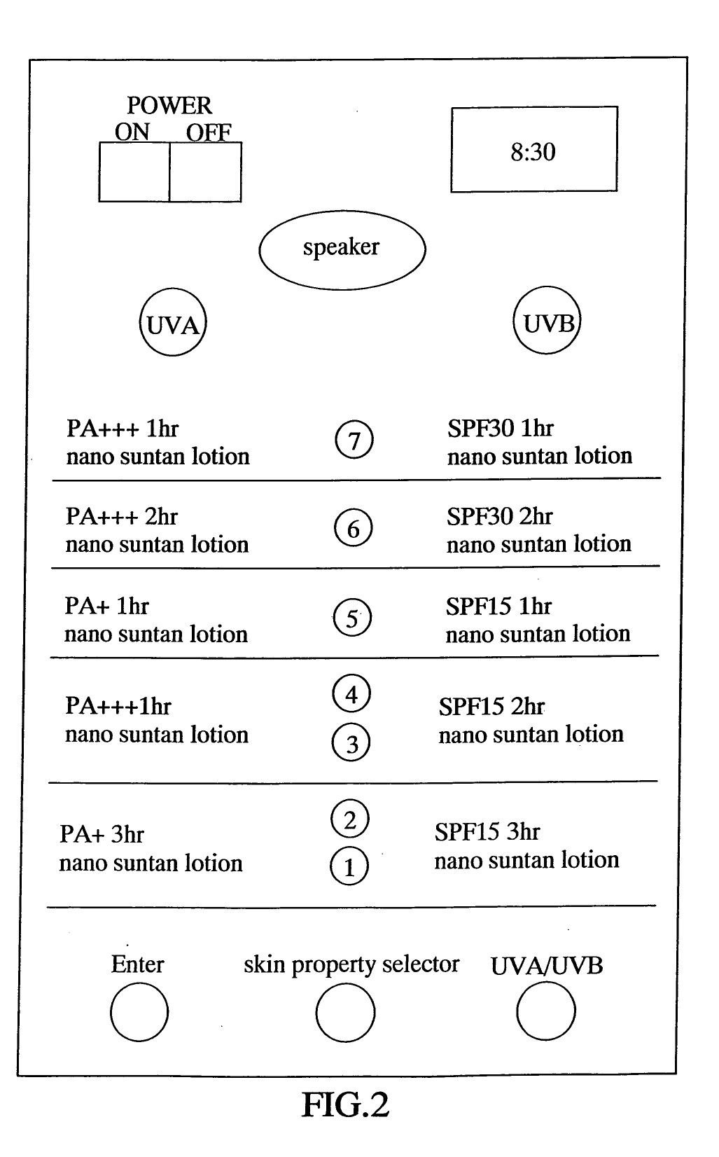

The present invention is provided to overcome the above problem. Referring to the drawings and initially to FIGS. 1 and 2, an apparatus for displaying the necessary suntan lotion and the skin care in accordance with the present invention comprises a UVA sensor and a UVB sensor respectively electrically connected to an operational (OP) amplifier that is electrically connected to a micro-processor. A UVA/UVB selector and a skin property selector are respectively electrically connected to the micro-processor. A series of light emitting diodes (LED) is electrically connected to the micro-processor for showing the suggests from the apparatus of the present invention. A speaker is electrically connected to the micro-processor.

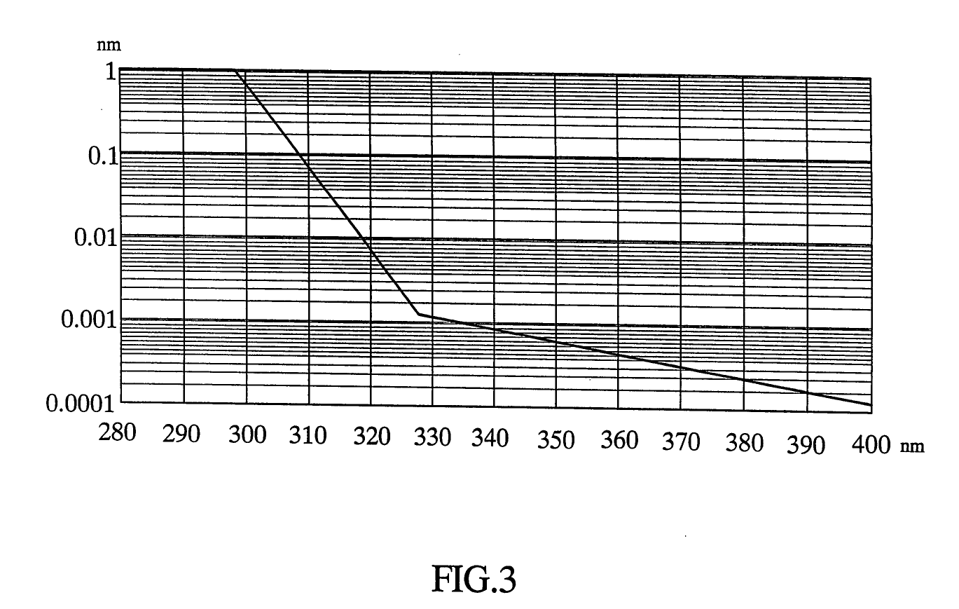

With reference to FIG. 3, the UVA sensor and the UVB sensor are selected due to the closest motive spectrum of the skin-erythema in FIG. 3. The measuring value from a corresponding one of the two selectors is calculated and transform to energy (unit−joule/m²) that hurts the human's skin. The human's skin is easily to be hurt when the energy is high.

The energy is calculated and analyzed to estimate that the energy will hurt the human's skin when exposed under the sunlight for several hours. Consequently, the apparatus can provide a suggestion including the sun protection factor (SPF) of the suntan lotion. For example, the human's skin may be hurt when A×T≧B, wherein the A is the instantaneous value of UV, the T is the time under the sunlight and the B is the maximum UV load of the human's skin. The above formula changed when the seclude rate (G) of the suntan lotion is considered, wherein G=sum of the secluded UV/maximum UV load of the human's skin. The human's skin may be hurt when A×T×(1−G)≧B.

The OP amplifier is selected according to the type of the photo diode of the UVA and UVB. The OP amplifier transforms the measured UV into a voltage signal that is transmitted to the micro-processor. The type of the amplifier may be changed when the type of the photo diode of the UVA and UVB is changed.

The micro-processor is an AID converter with multi-channel for receiving and calculating the voltage signal (0˜Vcc) to provide a relation of the suntan lotion and the skin care between the skin property and the UV parameter.

In the preferred embodiment of the present invention, the number of the series of LED is seven containing three colors (green, yellow and red for clearly showing the intensity of UV). The panel of the present invention needs to indicate the level of the intensity of UV and the suitable protection.

The speaker of the present invention is a coiled speaker and has a small size for reminding the user to apply suntan lotion. The sound of the speaker can be set as a noise, music or pronunciation.

As described above, the apparatus for displaying the necessary suntan lotion and the skin care in accordance with the present invention is portable, saving power and has a vivid appearance. In addition, the present invention accurately reminds the user to select a suitable suntan lotion or skin care to resist the sunlight.

Although the invention has been explained in relation to its preferred embodiment, it is to be understood that many other possible modifications and variations can be made without departing from the spirit and scope of the invention as hereinafter claimed.

What is claimed is:

1. An apparatus for displaying the necessary suntan lotion and the skin care, comprising a UVA sensor and a UVB sensor respectively electrically connected to an operational amplifier that is electrically connected to a micro-processor for transmitting signal to the micro-processor, a UVA/UVB selector and a skin property selector respectively electrically connected to the micro-processor for providing a calculating factor to the micro-processor, a series of light emitting diodes (LED) electrically connected to the micro-processor for showing the suggests from the micro-processor, a speaker electrically connected to the micro-processor for reminding the user to select a suitable suntan lotion.

2. The apparatus as claimed in claim 1, wherein the operational amplifier transforms the measured UV into a voltage signal that is transmitted to the micro-processor.

3. The apparatus as claimed in claim 1, wherein the number of the series of LED is seven containing three colors including green, yellow and red for clearly showing the intensity of UV.

4. The apparatus as claimed in claim 1, wherein the micro-processor is an AID converter with multi-channel for receiving and calculating the voltage signal from the operational amplifier to provide a relation of the suntan lotion and the skin care between the skin property and the UV parameter.

5. The apparatus as claimed in claim 1, wherein the speaker is a coiled speaker and has a small size for reminding the user to apply suntan lotion.

6. The apparatus as claimed in claim 5, wherein the speaker sounds a pronunciation for reminding the user.

7. The apparatus as claimed in claim 5, wherein the speaker sounds a noise for reminding the user.
